(19) United States
(12) Patent Application Publication
(10) Pub. No.: US 2016/0117625 A1
(43) Pub. Date: Apr. 28, 2016

(54) METHODS AND SYSTEMS FOR ASSESSING AN ORGANIZATION

(71) Applicants: Xerox Corporation, Norwalk, CT (US); Palo Alto Research Center Incorporated, Palo Alto, CA (US)

(72) Inventors: Meera Sampath, Rochester, NY (US); Markus Fromherz, Palo Alto, CA (US); Roy G Conlee, Lexington, KY (US)

(21) Appl. No.: 14/522,658

(22) Filed: Oct. 24, 2014

(51) Int. Cl. G06Q 10/06

(52) U.S. Cl. CPC G06Q 10/06393

(57) ABSTRACT

Methods and systems for assessing an organization. Values of each of one or more first parameters associated with a first dimension, and values of each of one or more second parameters associated with a second dimension, are received. The first dimension corresponds to an existing innovation strength of the organization. The second dimension corresponds to future innovation strength of said organization. A first rating and a second rating is assigned to each of first parameters and second parameters, respectively, associated with a first dimension and a second dimension, respectively. Based on the first rating and the second rating, a first score and a second score, respectively, is determined. The organization is categorized in one or more categories based on the first score and the second score. Further, the categorization of the organization is displayed through a user-interface on a display device.

### TECHNICAL FIELD

The presently disclosed embodiments are related, in general, to assessing an organization. More particularly, the presently disclosed embodiments are related to methods and systems for assessing innovation effectiveness of the organization.

### BACKGROUND

A typical organization may possess various innovation projects and associated innovation goals. In an embodiment, the organization may invest in research and development to procure and subsequently commercialize such innovation initiatives. However, measuring and assessing how well the organization is performing against its innovations goals has been a complex and difficult task. Typically, innovation efforts of the organization may be measured for individual innovation projects/portfolios. However, measuring the innovation effectiveness of the organization that captures the past, current, and future innovation strengths of the organization and that assesses the organization with respect to its competitors has been a non-trivial problem.

### SUMMARY

According to embodiments illustrated herein, there is provided a system for assessing an organization. The system includes a transceiver configured to receive values of each of one or more first parameters, associated with a first dimension, from one or more computing devices associated with the organization. The first dimension corresponds to an existing innovation strength of the organization. The transceiver is further configured to receive values of each of one or more second parameters, associated with a second dimension, from the one or more computing devices associated with the organization. The second dimension corresponds to future innovation strength of the organization. The system further includes one or more micro-processors configured to assign a first rating to each of the one or more first parameters based on the received values of each of the one or more first parameters. The one or more micro-processors are further configured to determine a first score corresponding to the first dimension based on at least the first rating. The one or more micro-processors are further configured to assign a second rating to each of the one or more second parameters based on the received values of each of the one or more second parameters. The one or more micro-processors are further configured to determine a second score corresponding to the second dimension based on at least the second rating. The one or more processors are further configured to categorize the organization in one or more categories based on the first score and the second score. The transceiver is further configured to send the categorization of the organization to the one or more computing devices. The categorization of the organization is displayed through a user-interface on a display device of the one or more computing devices.

According to embodiments illustrated herein, there is provided a method for assessing an organization. The method includes receiving, by a transceiver, values of each of one or more first parameters, associated with a first dimension, from one or more computing devices associated with the organization. The first dimension corresponds to an existing innovation strength of the organization. The method further includes receiving, by the transceiver, values of each of one or more second parameters, associated with a second dimension, from the one or more computing devices associated with the organization. The second dimension corresponds to future innovation strength of the organization. The method further includes assigning, by an one or more micro-processors, a first rating to each of the one or more first parameters based on the received values of each of the one or more first parameters. The method further includes determining, by the one or more micro-processors, a first score corresponding to the first dimension based on at least the first rating. The method further includes assigning, by the one or more micro-processors, a second rating to each of the one or more second parameters based on the received values of each of the one or more second parameters. The method further includes determining, by the one or more micro-processors, a second score corresponding to the second dimension based on at least the second rating. The method further includes categorizing, by the one or more micro-processors, the organization in one or more categories based on the first score and the second score. The method further includes sending, by the transceiver, the categorization of the organization to the one or more computing devices. The categorization of the organization is displayed through a user-interface on a display device of the one or more computing devices.

According to embodiments illustrated herein, there is provided a computer program product for use with a computer. The computer program product includes a non-transitory computer readable medium. The non-transitory computer readable medium stores a computer program code for assessing an organization. The computer program code is executable by one or more micro-processors to receive, by a transceiver, values of each of one or more first parameters, associated with a first dimension, from one or more computing devices associated with the organization. The first dimension corresponds to an existing innovation strength of the organization. The computer program code is further executable by one or more micro-processors to receive, by the transceiver, values of each of one or more second parameters, associated with a second dimension, from the one or more computing devices associated with the organization. The second dimension corresponds to future innovation strength of the organization. The computer program code is further executable by one or more micro-processors to assign a first rating to each of the one or more first parameters based on the received values of each of the one or more first parameters. The computer program code is further executable by the one or more micro-processors to determine a first score corresponding to the first dimension based on at least the first rating. The computer program code is further executable by the one or more micro-processors to assign a second rating to each of the one or more second parameters based on the received values of each of the one or more second parameters. The computer program code is further executable by the one or more micro-processors to determine a second score corresponding to the second dimension based on at least the second rating. The computer program code is further executable by the one or more micro-processors to categorize the organization in one or more categories based on the first score and the second score. The computer program code is further executable by the one or more micro-processors to send, by the transceiver, the categorization of the organization to the one or more computing devices. The categorization of the organization is displayed through a user-interface on a display device of the one or more computing devices.

### BRIEF DESCRIPTION OF DRAWINGS

The accompanying drawings illustrate various embodiments of systems, methods, and other aspects of the disclosure. Any person having ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit the scope in any manner, wherein like designations denote similar elements, and in which:

FIG. 1 is a block diagram illustrating a system environment in which various embodiments may be implemented;

FIG. 2 is a block diagram illustrating an application server, in accordance with at least one embodiment;

FIG. 3 is a message flow diagram illustrating flow of message/data between various components of the system environment, in accordance with at least one embodiment;

FIG. 4 is a flowchart illustrating a method for categorizing an organization, in accordance with at least one embodiment; and

FIG. 5 illustrates a block diagram for assessing one or more organizations, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment”, “an embodiment”, “at least one embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Definitions: The following terms shall have, for the purposes of this application, the respective meanings set forth below.

A “computing device” refers to a device including a processor/microcontroller and/or any other electronic component, or a device or a system that performs one or more operations according to one or more programming instructions. Examples of the computing device may include, but are not limited to, a desktop computer, a laptop, a personal digital assistant (PDA), a mobile device, a multifunctional device (MFD), a smartphone, a tablet computer (e.g., iPad®, and Samsung Galaxy Tab®), and the like.

A “first dimension” corresponds to a characterization of an organization's existing or current innovation strength. In an embodiment, the first dimension may include various first parameters that indicate the existing innovation strength of the organization. The first parameters may include, but are not limited to, a return on investment from innovation initiatives in the organization, a contribution of innovation in the organization's revenue, a contribution of innovation in the organization's profit growth, a count of innovations commercialized, a measure of strength of the organization to execute and/or commercialize innovation, and a measure of strength of the organization's innovation capability determined based on organization's rank among one or more competitor organizations.

A “second dimension” corresponds to a characterization of an organization's future innovation strength. In an embodiment, the second dimension may include various second parameters that may indicate the future innovation strength of the organization. The second parameters may include, but are not limited to, the organization's investment in innovation, a count of innovations in pipeline, a status of the organization's innovation strategy being aligned with said organization's overall strategy determinable from innovation roadmap of the organization, or an expected return on investment from innovation initiatives.

A “rating” corresponds to values associated with each of the one or more first parameters and the one or more second parameters. In an embodiment, a first rating corresponds to a cumulative measure of the first parameter (included in the first dimension) and a second rating corresponds to a cumulative measure of the second parameter (included in the second dimension).

A “score” refers to a metric that corresponds to at least one of the first dimension or the second dimension. In an embodiment, a first score corresponds to the first dimension and a second score corresponds to the second dimension. The first score may be determined based on the one or more first ratings and the second score may be determined based on the one or more second ratings.

A “category” refers to a class in which the organization belongs based on the first score and the second score. In an embodiment, based on the first score and the second score, the organization may be categorized in at least one of a leader category, a visionary category, a challenger category, or a niche player category.

A “leader category” refers to a category that indicates that the organization is well positioned today (e.g., measured through the first parameters associated with the first dimension) for executing its current innovation focus/goals, and is well positioned for tomorrow (e.g., measured through the second parameters associated with the second dimension) in terms of innovation vision, roadmap and investments. In an embodiment, the innovation vision of the organization may correspond to the future goals of the organization. Further, roadmap may correspond to the innovation strategy planned by the organization to achieve its innovation goals.

A “visionary category” refers to a category that indicates that the organization is well positioned for the future innovation growth but has observed weak record of accomplishment in terms of past innovation success.

A “challenger category” refers to a category that indicates that the organization has demonstrated strong execution toward its current innovation focus/goals, but may not be well positioned for tomorrow in terms of innovation vision, roadmap and investments.

A “niche player category” refers to a category that indicates that the organization neither has demonstrated strong execution toward its current innovation focus/goals, nor is well positioned for tomorrow in terms of the innovation vision, roadmap, and investment.

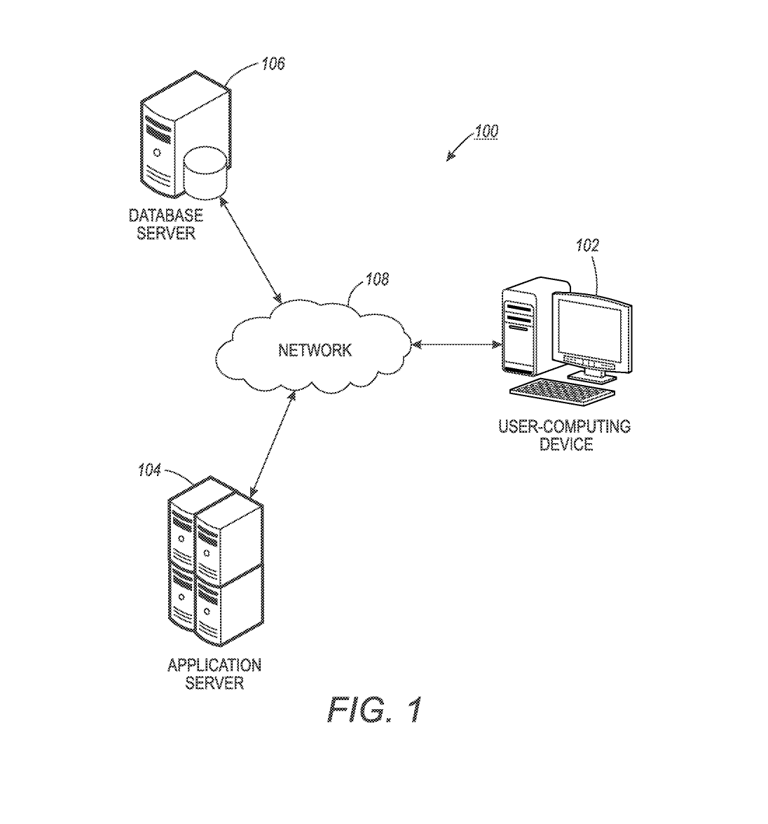

FIG. 1 is a block diagram illustrating a system environment 100 in which various embodiments may be implemented. The system environment 100 includes a user-computing device 102, an application server 104, a database server 106, and a network 108. Various devices in the system environment 100 (e.g., the user-computing device 102, the application server 104, and the database server 106) may be interconnected over the network 108.

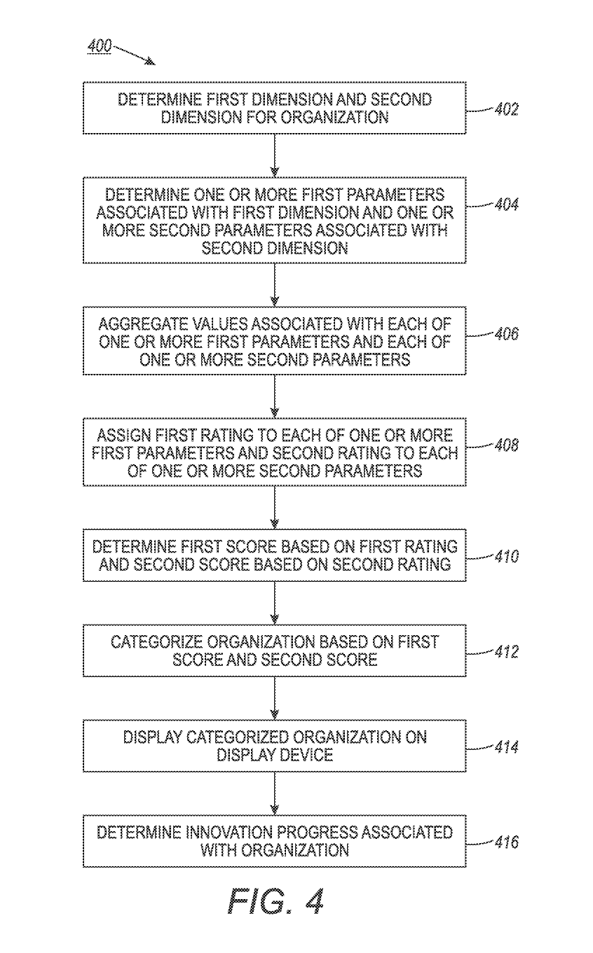

The user-computing device 102 refers to a computing device that a user may utilize to access the application server 104. In an embodiment, using the user-computing device 102, the user may define the one or more first parameters (included in the first dimension) and the one or more second parameters (included in the second dimension). Further, the user may provide values associated with the one or more first parameters and the values associated with one or more second parameters using the user-computer device 102. Details about the values associated with the one or more first parameters and the one or more second parameters will be discussed later in conjunction with the FIG. 4. The user may provide the inputs using input devices associated with the user-computing device 102 (e.g., keyboard, mouse, joystick, and touch interface). In an embodiment, a client application may be installed on the user-computing device 102 and the user may provide the inputs through an interface provided by the client application. In an alternate embodiment, the user may provide the inputs by accessing the application server 104 through a web-interface. Further, using the user-computing device 102, the user may instruct the application server 104 to determine the innovation effectiveness of the organization and to categorize the organization in at least one of the categories. Thereafter, the user-computing device 102 may receive information pertaining to the categorization of the organization from the application server 104, and the categorized organization may be displayed (e.g., in a Cartesian quadrant) through a user-interface on a display device associated with the user-computing device 102. The user-computing device 102 may include various types of the computing devices, such as, but not limited to, a desktop computer, a laptop, a personal digital assistant (PDA), a smart-phone, and a tablet computer (e.g., iPad®, Samsung Galaxy Tab®).

The application server 104 refers to a computing device that determines the innovation effectiveness of the organization. In an embodiment, the application server 104 may utilize the values (e.g., provided by the user through the user-computing device 102) associated with the one or more first parameters and the one or more second parameters to determine one or more first ratings and one or more second ratings. Further, based on the one or more first ratings and the one or more second ratings, the application server 104 may determine a first score associated with the first dimension and a second score associated with the second dimension. Subsequently, based on the first score and the second score, the application server 104 may categorize the organization in at least one of a leader category, a visionary category, a challenger category, or a niche player category. In an embodiment, the categorization of the organization is indicative of innovation effectiveness of the organization. Further details about the categorization of the organization will be discussed in conjunction with FIG. 4. In an embodiment, the application server 104 may be realized through various types of servers such as, but not limited to, Java server, .NET framework, and Base4 server.

The database server 106 refers to a computing device that may store information pertaining to the one or more first parameters and the one or more second parameters. For example, the database server 106 may store values associated with each of the one or more first parameters and the one or more second parameters. In an embodiment, the database server 106 may store a rating table. The rating table may include a mapping between the values associated with the first/second parameters and corresponding rating. Further, the database server 106 may store the one or more first ratings and the one or more second ratings (e.g., determined by the application server 104). In an embodiment, the database server 106 may store the first score and the second score determined by the application server 104. In an embodiment, the database server 106 may be accessed by the application server 104 to retrieve various types of information, as disclosed above. For example, the database server 106 may receive a query from the application server 104 to retrieve such information. For querying the database server 106, one or more querying languages may be utilized such as, but not limited to, SQL, QUEL, DMX and so forth. Further, the database server 106 may be realized through various technologies such as, but not limited to, Microsoft® SQL server, Oracle, and My SQL. In an embodiment, the database server 106 may connect to the application server 104, using one or more protocols such as, but not limited to, ODBC protocol and JDBC protocol.

It will be apparent to a person skilled in the art that the functionalities of the database server 106 may be incorporated into the application server 104, without departing from the scope of the disclosure. In such a scenario, various types of the information, as disclosed above, may be stored in the application server 104.

The network 108 corresponds to a medium through which content and messages flow between various devices of the system environment 100 (e.g. the user-computing device 102, the application server 104, and the database server 106). Examples of the network 108 may include, but are not limited to, a Wireless Fidelity (Wi-Fi) network, a Wide Area Network (WAN), a Local Area Network (LAN), or a Metropolitan Area Network (MAN). Various devices in the system environment 100 can connect to the network 108 in accordance with various wired and wireless communication protocols such as Transmission Control Protocol and Internet Protocol (TCP/IP), User Datagram Protocol (UDP), and 2G, 3G, or 4G communication protocols.

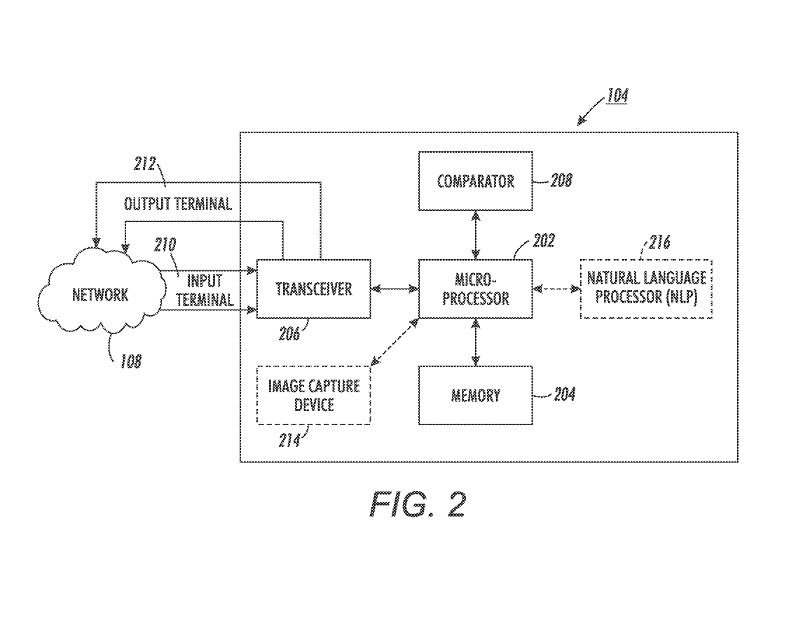

FIG. 2 is a block diagram illustrating the application server 104, in accordance with at least one embodiment. The application server 104 includes a micro-processor 202, a memory 204, and a transceiver 206, and a comparator 208. The micro-processor 202 is coupled to the memory 204, the transceiver 206, and the comparator 208. The transceiver 206 is connected to the network 108 through an input terminal 210 and an output terminal 212. In an embodiment, the application server 104 may also include an image capture device 214 and a natural language processor (NLP) 216 coupled to the micro-processor 202.

The micro-processor 202 includes suitable logic, circuitry, and/or interfaces that are operable to execute one or more instructions stored in the memory 204 to perform predetermined operation. The memory 204 may be operable to store the one or more instructions. The micro-processor 202 may be implemented using one or more processor technologies known in the art. Examples of the micro-processor 202 include, but are not limited to, an X86 processor, a RISC processor, an ASIC processor, a CISC processor, or any other processor.

The memory 204 stores a set of instructions and data. Some of the commonly known memory implementations include, but are not limited to, a random access memory (RAM), a read only memory (ROM), a hard disk drive (HDD), and a secure digital (SD) card. Further, the memory 204 includes the one or more instructions that are executable by the micro-processor 202 to perform specific operations. It will be apparent to a person having ordinary skill in the art that the one or more instructions stored in the memory 204 enables the hardware of the application server 104 to perform the predetermined operation.

The transceiver 206 transmits and receives messages and data to/from various components of the system environment 100. In an embodiment, the transceiver 206 is coupled to the input terminal 210 and the output terminal 212 through which the transceiver 206 may receive and transmit data/messages respectively. Examples of the transceiver 206 may include, but are not limited to, an antenna, an Ethernet port, an USB port or any other port that can be configured to receive and transmit data. The transceiver 206 transmits and receives data/messages in accordance with the various communication protocols, such as, TCP/IP, UDP, and 2G, 3G, or 4G communication protocols.

The comparator 208 is configured to compare at least two input signals to generate an output signal. In an embodiment, the output signal may correspond to either ‘1’ or ‘0’. In an embodiment, the comparator 208 may generate output ‘1’ if the value of a first signal (from the at least two signals) is greater than a value of the second signal (from the at least two signals). Similarly, the comparator 208 may generate an output ‘0’ if the value of the first signal is less than the value of the second signal. In an embodiment, the comparator 208 may be realized through either software technologies or hardware technologies known in the art. Though, the comparator 208 is depicted as independent from the micro-processor 202 in FIG. 2, a person skilled in the art would appreciate the comparator 208 may be implemented within the micro-processor 202 without departing from the scope of the disclosure.

In addition, in an embodiment, the application server 104 may include an image capture device 214 coupled to the micro-processor 202. The image capture device 214 may be inbuilt within the application server 104. Alternatively, the image capture device 214 may be separate from the application server 104, but communicatively coupled with the application server 104. In an embodiment, the image capture device 214 may correspond to, but is not limited to, a scanner, a Multi-Function Device, or a camera. In an embodiment, the image capture device 214 may be implemented through one or more scanning technologies such as, but not limited to, reduction type linear sensor based scanning and Contact Image Sensor (CIS) based scanning. In an embodiment, image capture device 214 may scan one or more documents such as financial documents associated with the organization. The financial documents may contain information pertaining to the return on investments made on research and development (R&D) projects by the organization.

Further, the application server 104 may include the natural language processor (NLP) 216 coupled to the micro-processor 202. In an embodiment, the NLP 216 is a micro-processor configured to analyze natural language content to draw meaningful conclusions therefrom. In an embodiment, the NLP 216 may employ one or more natural language processing and one or more machine learning techniques known in the art to perform the analysis of the natural language content. Examples of such techniques include, but are not limited to, Naïve Bayes classification, artificial neural networks, Support Vector Machines (SVM), multinomial logistic regression, or Gaussian Mixture Model (GMM) with Maximum Likelihood Estimation (MLE). In an embodiment, the NLP 216 may analyze the one or more documents scanned by the image capture device 214 by using one or more techniques such as OCR, ICR, and part of speech tagging. In an embodiment, the values of the first parameters and the second parameters may be extracted/determined based on the analysis of the one or more documents by the NLP 216.

Though the NLP 216 is depicted as separate from the micro-processor 202 in FIG. 2, a person skilled in the art would appreciate that the functionalities of the NLP 216 may be implemented within the micro-processor 202 without departing from the scope of the disclosure.

The operation of the application server 104 for categorizing the organization will be described in conjunction with FIG. 4.

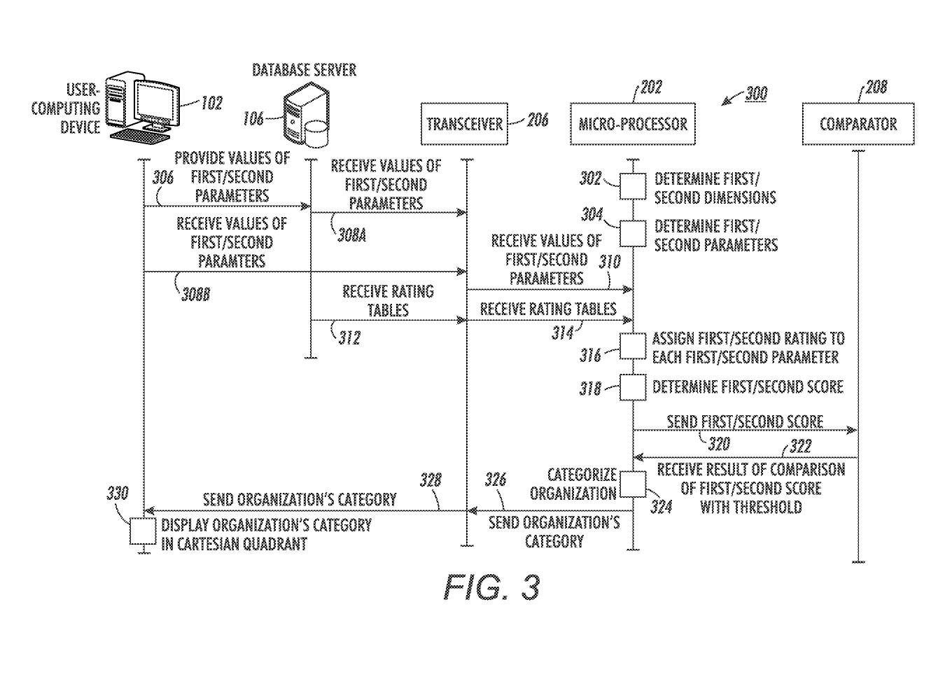

FIG. 3 is a message flow diagram 300 illustrating flow of message/data between various components of the system environment 100, in accordance with at least one embodiment.

As shown in FIG. 3, the micro-processor 202 may determine first and second dimensions based on user-input (depicted by 302). The determination of the first and the second dimensions has been explained further in step 402. Further, the micro-processor 202 may determine first and second parameters, which are associated with the first and the second dimensions, respectively, based on user-input (depicted by 304). The determination of the first and the second parameters has been further explained in step 404.

Various users of the user-computing device 102 may provide values of the first and the second parameters, which may be stored on the database server 106 (depicted by 306). Thereafter, the transceiver 206 may receive the values of the first and the second parameters from the database server 106 (depicted by 308a). Alternatively, the transceiver 206 may directly receive the values of the first and the second parameters from the user-computing device 106 (depicted by 308b). The micro-processor 202 may in-turn receive these values from the transceiver 206 (depicted by 310). The micro-processor 202 may aggregate the received values of the first and the second parameters, as explained further in step 406.

In an alternate embodiment, the application server may include an image capture device (e.g., the image capture device 214) that may scan one or more documents containing information pertaining to the first parameters and the second parameters. The application server 104 may further include a natural language processor (e.g., the NLP 216) that may analyze the one or more documents by using one or more techniques such as OCR, ICR, and part of speech tagging to extract/determine values of the first parameters and the second parameters. In an embodiment, the one or more documents may correspond to financial documents that may contain information pertaining to the return on investments made on research and development (R&D) projects by the organization. The financial documents may also contain a projection of future expected returns on investments on R&D projects.

Thereafter, the micro-processor 202 may extract rating tables for the first and the second parameters from the database server 106. The micro-processor 202 may receive the extracted rating tables from the database server 106 through the transceiver 206 (depicted by 312 and 314). In an embodiment, the rating tables may include a mapping between each of the first parameters and the second parameters with the respective ratings. In an embodiment, the rating may be determined based one or more predefined rules. In an embodiment, the one or more predefined rules may correspond to a fuzzy rule set that may be used to translate the first parameters and the second parameters in to respective ratings. Based on such mappings in the extracted rating tables, the micro-processor 202 may assign a first rating to each of the first parameters and a second rating to each of the second parameters (depicted by 316). The assignment of the first and the second ratings has been further explained in step 408. Thereafter, the micro-processor 202 may determine a first score and a second score for the organization based on the first and the second ratings (depicted by 318). Further, the micro-processor 202 may send the first score and the second score to the comparator 208 for comparison with pre-defined threshold(s) (depicted by 320). The micro-processor 202 receives results of the comparison from the comparator 208 (depicted by 322). Thereafter, the micro-processor 202 categorizes the organization based on the result of the comparison (depicted by 324). The categorization of the organization based on the first and the second scores has been explained further in step 412.

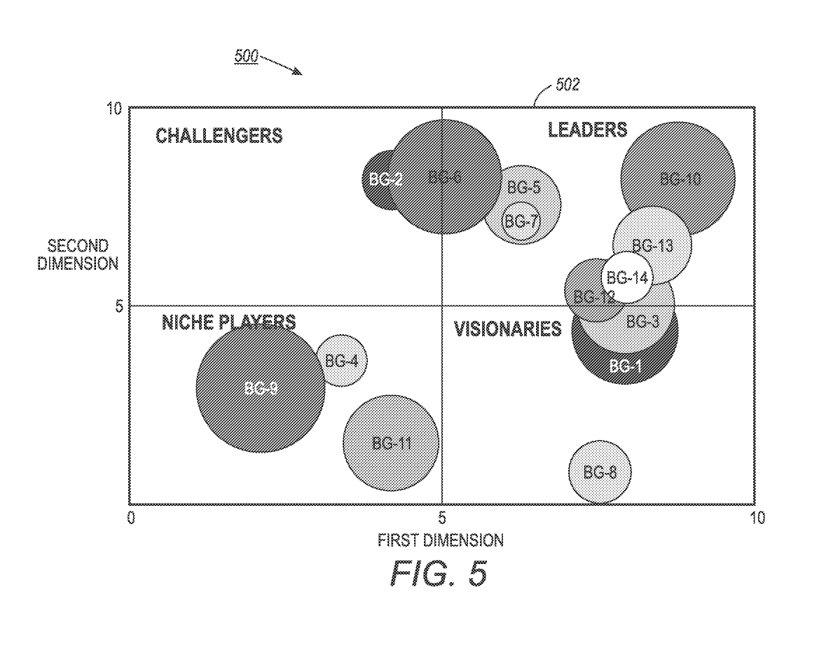

Further, as shown in FIG. 3, the micro-processor 202 may send information pertaining to the organization's categorization to the user-computing device 102 for display through the transceiver 206 (depicted by 326 and 328). Based on the received information, the user-computing device 102 may display the organization's categorization in a Cartesian quadrant on a display device (depicted by 330). For example, the organization's categorization may be displayed on a bubble chart in a Cartesian coordinate space with the size of the bubble being proportional to the organization's size, innovation ability, revenue, growth potential, etc. Further details regarding display of the organization's categorization have been provided in step 414 and in conjunction with FIG. 5.

FIG. 4 is a flowchart 400 illustrating a method for categorizing the organization, in accordance with at least one embodiment. The flowchart 300 is described in conjunction with FIG. 1 and FIG. 2.

At step 402, the first dimension and the second dimension are determined by the micro-processor 202. The user may have defined each of the first dimension and the second dimension such that the first dimension is indicative of the existing innovation strength of the organization, and the second dimension is indicative of the future innovation strength of the organization. An illustration of the first/second dimension for an organization is discussed in conjunction with the FIG. 5.

At step 404, the one or more first parameters associated with the first dimension and the one or more second parameters associated with the second dimension are determined by the micro-processor 202. In an embodiment, the user may have defined the one or more first parameters that are to be included in the first dimension and the one or more second parameters that are to be included in the second dimension. For example, the user, who wants to determine the innovation effectiveness of the organization, may define different first/second parameters in each of the first/second dimensions to capture the innovation effectiveness. In an embodiment, the one or more first parameters correspond to at least one of a return on investment from innovation initiatives in the organization, a contribution of innovation in the organization's revenue, a contribution of innovation in the organization's profit growth, a count of innovations commercialized, a measure of strength of the organization to execute and/or commercialize innovation, or a measure of strength of the organization's innovation capability determined based on organization's rank among one or more competitor organizations. In an embodiment, the one or more second parameters correspond to at least one of the organization's investment in innovation, a count of innovations in pipeline, a status of the organization's innovation strategy being aligned with the organization's overall strategy determinable from innovation roadmap of the organization, or an expected return on investment from innovation initiatives. Detailed description of each of the one or more first parameters and the one or more second parameters is as follows:

### First Parameters:

Return on investment from innovation initiatives: In an embodiment, the return on investment from the innovation initiatives in the organization corresponds to a measure of efficiency of the investment made by the organization for the innovation projects. In an embodiment, the return on investment from innovation initiatives may be determined by using the following equation:

$$Return on investment = \frac{Net profit}{Investment} \qquad ( 1 )$$

where,

Net profit=Net profit made by the organization from the innovation initiatives, and

Investment=Net investment made by the organization in the innovation initiatives.

For example, if an organization ABC made a net profit of $1 million from innovation initiatives and a net investment of $100 million in innovation initiatives, the micro-processor 202 may utilize the equation (1) to determine the return of investment as:

$$Return on investment = \frac{1}{100} = 1 \%$$

In an alternate embodiment, the return on investment for the organization may be determined as:

$$Return on investment = \frac{Innovation revenue + 50 \% of profit}{Group revenue} \qquad ( 2 )$$

where,

innovation revenue=revenue earned by the organization from the innovation initiatives,

profit=net profit made by the organization from the innovation initiatives, and

Group revenue=Total revenue earned by the organization.

Considering the example of organization ABC, if the innovation revenue from the innovation initiatives, net profit from the innovation initiatives, and the total revenue earned by the organization are $10 million, $1, and $1 billion, respectively, the micro-processor 202 may utilize the equation (2) to determine the return on investment as:

$$Return on investment = \frac{10 + 0.5}{1000} = 1.05 \%$$

Contribution of innovation in the organization's revenue: In an embodiment, the contribution of innovation in the organization's revenue corresponds to a ratio of the revenue, from innovation, earned by the organization, and the total revenue earned by the organization, i.e.:

$$Contribution of innovation in revenue = \frac{Revenue from innovation}{Group revenue} \qquad ( 3 )$$

For example, if the organization ABC has earned a revenue of $1 million from innovation, and the total revenue for the organization ABC is $100 million, the contribution of innovation in revenue will be:

$$Contribution of innovation in revenue = \frac{1}{100} = 1 \%$$

In a similar way, the contribution of innovation in the organization's profit growth corresponds to a ratio of the profit growth, from innovation, earned by the organization, and the total profit growth earned by the organization, i.e.:

$$Contribution of innovation in profit growth = \frac{Profit growth from innovation}{Total profit growth} \qquad ( 4 )$$

In an embodiment, each of the values corresponding to the organization (e.g., net profit, investment, innovation revenue, profit, group revenue, and profit growth) as used in equations (1)-(4) may be determined for the current and previous year; however, it will be apparent to a person skilled in the art that these values may be determined for any number of years provided by the user. Further, the equations discussed above may be modified/customized by the user based on his/her requirements for gathering information about the innovation effectiveness of the organization.

Count of innovations commercialized: In an embodiment, the count of the innovations commercialized may correspond to the count of innovation projects, initiated by the organizations that have been successfully commercialized. The information for such count may be provided by the user. For example, if the organization ABC had initiated 10 innovation projects and three innovation projects were commercialized (e.g., in the current and previous year), the count of innovation projects commercialized will be three. In an embodiment, the user may provide the count corresponding to different types of innovations that have been commercialized by the organizations (e.g., sustaining innovation initiatives and transformational innovation initiatives). In an embodiment, sustaining innovation initiatives may refer to incremental innovations by the organization, such that the incremental innovations result in an improved offering by the organization, but does not substantially change the offering, its delivery, or its business model. In an embodiment, the transformational innovation initiatives may refer to the innovations that may substantially change the development/delivery of the offering, but may not change its business model.

In an embodiment, the measure of strength of the organization to execute and/or commercialize innovation may correspond to a numerical value provided by the user. For example, the user may provide a value of four (on a scale of 10) corresponding to the measure of strength of the organization to execute and/or commercialize innovation. The user may provide the value based on his/her understanding of the innovation projects being executed in the organization. In a similar way, the user may provide the measure of strength of the organization's innovation capability determined based on organization's rank among one or more competitor organizations.

### Second Parameters:

Organization's investment in innovation: In an embodiment, the organization's investment in innovation may correspond to investment made by the organization as a percentage of the organization's overall revenue. For example, for an investment of $1 million in innovations projects against a group revenue of $100 million, the value for the second parameter “organization's investment in innovation” will be 1%. In an embodiment, the user, who wants to categorize the organization in the at least one category, may provide the organization's investment in different types of innovations projects (e.g., transformational innovation projects and disruptive innovation projects). In an embodiment, the disruptive innovations may refer to innovations that may significantly change the offering, such that the changes may require mastery of new competencies by the organization and may displace incumbent offering. In addition, such changes in disruptive innovation may enable or even require a new business model.

Count of innovations in pipeline: In an embodiment, the count of the innovations in pipeline may correspond to the count of the each of the transformational/disruptive innovation projects that have to be initiated by the organization. The user may provide the count using the user-computing device 102.

Status of organization's innovation strategy: In an embodiment, the user may also provide the status of the organization's innovation strategy, e.g., whether it is aligned with the organization's overall strategy. The user may determine the status based on the innovation roadmap planned by the organization, and may provide the value in terms of Yes/No. Subsequently, the micro-processor 202 may determine a numerical value (e.g., value of 0 for “No” and value of 1 for “Yes”).

Expected return on innovation investment: In an embodiment, the expected return on investment from innovation initiatives may correspond to an estimation made by the user about the return on investment from innovation initiatives. The user may utilize equation (1) or equation (2) to predict the return on investment based on expected innovation profit/investment of the organization. For example, the user may provide an expected return in 3 years from the start of the commercialization of the innovation initiatives made by the organization.

At step 406, the values corresponding to each of the one or more first parameters and the one or more second parameters are aggregated. In an embodiment, the micro-processor 202 may aggregate the values from the database server 106. For example, the user may have provided different values corresponding to each of the first/second parameters (e.g., at the start of the month/year), and subsequently, the micro-processor 202 may extract such values from the database server 106. In an alternate embodiment, the user may provide different values by accessing the application server 104 over the web-interface, as discussed above.

In an alternate embodiment, the application server 104 may include an image capturing device to scan one or more documents containing information pertaining to the first parameters and the second parameters. The application server 104 may further include a natural language processor that may analyze the one or more documents by using one or more techniques such as OCR, ICR, and part of speech tagging to extract/determine values of the first parameters and the second parameters. In an embodiment, the one or more documents may correspond to financial documents that may contain information pertaining to the return on investments made on research and development (R&D) projects by the organization. The financial documents may also contain a projection of future expected returns on investments on R&D projects.

Table 1 and Table 2 illustrate the values corresponding to the one or more first parameters (included in the first dimension) and the one or more second parameters (included in the second dimension), respectively, aggregated by the micro-processor 202:

TABLE 1
Illustration of the values of the one or more first parameters

| First parameter | Value |
|---|---|
| Return on investment from innovation | 0.5% |
| initiatives | |
| Contribution of innovation in organization | 0.3% |
| revenue | |
| Contribution of innovation in | 2% |
| organization's profit growth | |
| Count of innovation commercialized | 2 |
| Measure of strength of the organization to | 3 |
| execute and/or commercialize innovation | |
| Measure of strength of the organization's | 4 |
| innovation capability | |

TABLE 2
Illustration of the values of the one or more second parameters

| Second parameter | Value |
|---|---|
| Organization's investment in innovation | 2% |
| Count of innovation in pipeline | 4 |
| Status of organization's innovation | Yes |
| strategy | |
| Expected return in investment from | 1.5% |
| innovation initiative | |

As discussed above, the values of different parameters may be provided by the user. For example, as depicted in the Table 1, the user may provide that the count of innovation initiatives that have been successfully commercialized is two. As discussed, the count may correspond to any number of years (e.g., current year+two previous years) preferred by the user. In a similar manner, the user may provide different values for other parameters. Further, as discussed, the values for various parameters (e.g., measure of strength of the organization to execute and/or commercialize innovation and the measure of strength of the organization's innovation capability) may be provided by the user on a scale of 1-10, as depicted in Table 1 and Table 2.

In an alternate embodiment, the micro-processor 202 may aggregate different values, as depicted in Table 1 and Table 2, from a management information system (MIS) or an enterprise resource planning (ERP) system of the organization. For example, the organization may choose to include different parameters in the MIS/ERP dashboards published by the organization, and subsequently, the micro-processor 202 may aggregate the values from such dashboards.

Further, it will be apparent to a person skilled in the art that the first/second parameters depicted in Table 1 and Table 2 are only for illustration purposes and other parameters than the depicted ones may also be chosen by the user, without departing from the scope of the disclosure.

At step 408, a first rating to each of the one or more first parameters and a second rating to each of the one or more second parameters is assigned. In an embodiment, the micro-processor 202 assigns the first/second ratings to each of the one or more first/second parameters based on the values aggregated in the previous step (i.e., the step 406). In an embodiment, the micro-processor 202 may extract the rating table from the database server 106, and based on the mapping between the values of the first/second parameters and the first/second rating included in the rating table, the micro-processor 202 may determine the first/second rating. In an embodiment, the micro-processor 202 may determine the rating based one or more predefined rules. In an embodiment, the one or more predefined rules may correspond to a fuzzy rule set that may be used to translate the first parameters and the second parameters in to respective ratings. Table 3 and Table 4 illustrate the rating tables corresponding to the one or more first parameters and the one or more second parameters, respectively:

TABLE 3
Illustration of the rating table corresponding to the first parameters

| | Rating | | | | |
|---|---|---|---|---|---|
| First parameter | 0 | 2.5 | 5 | 7.5 | 10 |
| Return on investment | <1% | 1-2% | 2-3% | 3-5% | >5% |
| from innovation initiatives | | | | | |
| Contribution of innovation | 0% | <40% | 40-60% | 60-80% | >80% |
| in organization revenue | | | | | |
| Contribution of innovation | 0% | <40% | 40-60% | 60-80% | >80% |
| in organization's profit | | | | | |
| growth | | | | | |
| Count of innovation | 0 | 1-2 | 3 | 4 | >=5 |
| commercialized | | | | | |
| Measure of strength of the | — | — | — | — | — |
| organization to execute | | | | | |
| and/or commercialize | | | | | |
| innovation | | | | | |
| Measure of strength of the | — | — | — | — | — |
| organization's innovation | | | | | |
| capability | | | | | |

TABLE 4
Illustration of the rating table corresponding to the second parameters

| | Rating | | | | |
|---|---|---|---|---|---|
| Second parameter | 0 | 2.5 | 5 | 7.5 | 10 |
| Organization's | <1% | 1-2% | 2-3% | 3-5% | >5% |
| investment in | | | | | |
| innovation | | | | | |
| Count of | 0 | 1-2 | 3 | 4-5 | >5 |
| innovation in | | | | | |
| pipeline | | | | | |
| Status of | No | Yes, somewhat | Yes, somewhat | Yes, well | Yes, strongly |
| organization's | | aligned with | aligned with | aligned with | aligned with |
| innovation | | either business | business | either business | both business |
| strategy | | strategy or | strategy and | strategy or | strategy and |
| | | industry trends | industry trends | industry trends | industry trends |
| | | | | and comprehends | |
| | | | | other somewhat | |
| Expected return | 0 | 1-2 | 3 | 4 | >=5 |
| in investment | | | | | |
| from innovation | | | | | |
| initiative | | | | | |

It can be observed that Table 3 maintains a mapping between different values of the first parameters and the corresponding first rating. For example, it can be observed that for the value of <1% for the first parameter “Return on investment from innovation initiatives”, the corresponding first rating is zero, whereas for the value range of 2-3% (for the same first parameter), the first rating is five. In a similar way, mapping of other values has been illustrated. Further, the values for the last two parameters in Table 3 (i.e., “Measure of strength of the organization to execute and/or commercialize innovation”, and “Measure of strength of the organization's innovation capability”) has not been illustrated, since the first rating corresponding to these two parameters may directly be provided by the user (e.g., on a scale of 1-10).

In a similar way, Table 4 illustrates different second parameters (included in the second dimension) and corresponding second ratings. For example, it can be observed from Table 4 that the value of 2-3% for the second parameter “Organization's investment in innovation” corresponds to a second rating of five.

At step 410, the first score and the second score are determined. In an embodiment, the micro-processor 202 determines the first score and the second score based on the first rating and the second rating, respectively. As discussed above, the first score corresponds to the one or more first parameters (included in the first dimension) and the second score corresponds to the one or more second parameters (included in the second dimension). That is, the first score corresponds to the current/existing innovation strength of the organization and the second score corresponds to the future innovation strength of the organization. In an embodiment, higher value of the first score associated with the first dimension indicates that the organization is well positioned for today to execute its innovation goals/focus. In a similar manner, higher value of the second score associated with the second dimension indicates that the organization is well positioned for tomorrow in terms of innovation vision, innovation roadmap, and innovation investment. In an embodiment, the micro-processor 202 may utilize below equation to determine the first score corresponding to the first dimension:

$$First Score = \frac{2 * E 1 + 2 * E 2 + E 3 + 2 * E 4}{7} \qquad ( 5 )$$

where,

E1=first parameter: Return on investment from innovation initiatives,

E2=first parameter: Contribution of innovation in organization revenue,

E3=first parameter: Count of sustaining innovation commercialized, and

E4=first parameter: Count of transformational innovation commercialized.

In an embodiment, the micro-processor 202 may utilize the equation (5) to determine the first score based on the values of the first parameter (refer Table 1). In an embodiment, the equation for determining the first score may be modified by the user. In addition, though the equation (5) for determining the first score involves only some of the first parameters, the equation for determining the first score may be modified to include all the first parameters discussed in conjunction with the step 404.

Further, a person having ordinary skill would understand that different weights can be assigned to the different parameters to determine first score. In such a scenario the equation 5 may be modified as:

$$First Score = \frac{w 1 * E 1 + w 2 * E 2 + w 3 * E 3 + w 4 * E 4}{w 1 + w 2 + w 3 + w 4} \qquad ( 6 )$$

where,

w1, w2, w3, and w4 are different weights assigned by the user to respective parameters.

In an embodiment, the second score corresponding to the second dimension may be determined by using following equation:

$$Second Score = \frac{V 1 + V 2 + 2 * V 3 + 2 * V 4}{6} \qquad ( 7 )$$

where,

V1=second parameter: Organization's investment in innovation,

V2=second parameter: Count of innovation in pipeline,

V3=second parameter: Status of organization's innovation strategy, and

V4=second parameter: Expected return in investment from innovation initiative.

In an embodiment, the user may modify the equation (7) to determine the second score based on his/her requirement. For example, weights assigned to different second parameters, as depicted in the equation (7), may be customized by the user based on the specific requirements. In such a scenario, the second score corresponding to the second dimension may be determined as:

$$Second Score = \frac{w 1 * V 1 + w 2 * V 2 + w 3 * V 3 + w 4 * V 4}{w 1 + w 2 + w 3 + w 4} \qquad ( 8 )$$

where,

w1, w2, w3, and w4 are different weights assigned by the user to respective parameters.

In an embodiment, the micro-processor 202 may store the first scores and the second scores corresponding to different organizations in the database server 106.

At step 412, the micro-processor 202 categorizes the organization. In an embodiment, the micro-processor 202 categorizes the organization based on the first score and the second score corresponding to the first dimension and the second dimension. In an embodiment, the micro-processor 202 determines four categories corresponding to four combination of the first score and the second score. The four combinations of the first score and the second score may be: high first score and high second score, high first score and low second score, low first score and high second score, and low first score and low second score. Further, the threshold value for the first/second score may be provided by the user, based on which the first/second score is determined as low/high. In an embodiment, the micro-processor 202 may utilize the comparator 208 to compare the first score and the second score with the respective threshold values. For example, the user may provide the threshold values as five for each of the first dimension and the second dimension, and the micro-processor 202 (by utilizing the comparator 208) may determine four combinations of the values based on this threshold value. Subsequently, the micro-processor 202 may categorize the organization in at least one of a leader category, a challenger category, a visionary category, or a niche player category. Table 5 illustrates such four combination of the values of the first/second score and corresponding categorization:

TABLE 5
Illustration of the four combinations of the values of the
first/second score and corresponding categorization.

| Category | Value of first score | Value of second score |
|---|---|---|
| Leader | ≧5 | ≧5 |
| Visionary | ≧5 | <5 |
| Challenger | <5 | ≧5 |
| Niche Player | <5 | <5 |

It can be observed from Table 5 that for the leader category, the first and second, both scores are on higher side; whereas for the category niche player, the first and second, both scores are on lower side. Further illustration of the categorization of the organization based on the first/second score will be discussed in conjunction with the FIG. 5.

At step 414, the categorized organization is displayed to the user. In an embodiment, the micro-processor 202 may display the categorized organization on the display device associated with the user-computing device 102. For example, when the user accesses the application server 104 through the client application installed on the user-computing device 102, the micro-processor 202, post determining the category of the organization, may transmit the categorization information to the user-computing device 102 for the display. In an embodiment, the categorized organization may be displayed in the Cartesian quadrant on the display device. For example, in the Cartesian quadrant, each of the quadrant may correspond to one of category, discussed above (i.e., the leader category, the visionary category, the challenger category, and the niche player category).

In an embodiment, the categorized organization may be displayed in a bubble-chart on the display device. In such a scenario, different organizations may be depicted through different bubbles in the bubble-chart. Further, the size of the bubbles in the bubble-chart may correspond to organization's size (e.g., in terms of revenue). It will be apparent to a person skilled in the art that such bubble-chart may be utilized by the user in determining the innovation effectiveness of the organization. Further illustration of the display of the organization will be discussed in conjunction with FIG. 5.

At step 416, the innovation progress of the organization may be determined. In an embodiment, the micro-processor 202 may determine the innovation progress based on the categorization of the organization. For example, the micro-processor 202 may compare the categorization of the organization for two different periods, and based on the variation in the categorization (or the variation in the first score and the second score), the micro-processor 202 may determine the innovation progress of the organization. Subsequently, the user may utilize the determination for different decisions/strategies for achieving innovation goals of the organization.

FIG. 5 illustrates a block diagram 500 for assessing one or more organizations, in accordance with at least one embodiment. The block diagram 500 includes a bubble chart 502 that corresponds to the assessment of 14 organizations (represented by BG-1-BG-14). The organizations BG-1-BG-14 are categorized in the at least one category (i.e., the leader, the visionary, the challenger, and the niche player). FIG. 5 will be explained now in conjunction with FIG. 4.

In accordance with step 402 to step 406, the micro-processor 202 aggregates the values corresponding to the one or more first parameters and the one or more second parameters (e.g., represented by Table 1 and Table 2). With reference to the block diagram 500, the values of the first/second parameters corresponding to each of the fourteen organizations BG-1-BG-14 are aggregated. Table 6 illustrates such aggregated values of the one or more first parameters and the one or more second parameters corresponding to the organizations BG-1-BG-14:

TABLE 6
Illustration of the aggregated values for block diagram 500

| | Group | | | | | | | | |
|---|---|---|---|---|---|---|---|---|---|
| Organi- | revenue | First dimension | | | | Second dimension | | | |
| zation | ($ millions) | E1 | E2 | E3 | E4 | V1 | V2 | V3 | V4 |
| BG-1 | 914.14 | 4% | 50% | 3 | 0 | 4% | 3 | Yes | 5 |
| BG-2 | 295.11 | 6% | 82% | 4 | 3 | 2.5% | 0 | Yes | 4 |
| BG-3 | 821.39 | 4% | 30% | 3 | 3 | 4.2% | 6 | Yes | 3 |
| BG-4 | 242.27 | 1.5% | 85% | 0 | 0 | 1.2% | 0 | Yes | 3 |
| BG-5 | 530.32 | 6% | 82% | 4 | 1 | 6% | 3 | Yes | 3 |
| BG-6 | 1212.75 | 5.5% | 81% | 4 | 3 | 2.2% | 3 | Yes | 2 |
| BG-7 | 117.40 | 7% | 63% | 5 | 2 | 2.7% | 3 | Yes | 4 |
| BG-8 | 338.39 | 0.5% | 32% | 0 | 0 | 5.5% | 3 | Yes | 6 |
| BG-9 | 1353.67 | 2.5% | 35% | 3 | 0 | 1.1% | 0 | Yes | 2 |
| BG-10 | 1006.67 | 5.5% | 87% | 1 | 4 | 1% | 6 | Yes | 5 |
| BG-11 | 786.82 | 1% | 30% | 0 | 0 | 3.2% | 0 | Yes | 3 |
| BG-12 | 372.78 | 4% | 87% | 2 | 0 | 3.3% | 3 | Yes | 7 |
| BG-13 | 528.83 | 6% | 92% | 0 | 1 | 5.1% | 3 | Yes | 6 |
| BG-14 | 227.42 | 4% | 91% | 0 | 2 | 4% | 3 | Yes | 5 |

As discussed in conjunction with step 406, the micro-processor 202 may aggregate the values from the database server 106, where the user may have stored these values. Further, the user may update the values on a periodic basis (e.g., at the start of every month/quarter/year). In an alternate embodiment, the user may provide the raw information (such as overall revenue of organization, profit from innovation projects, etc.), and subsequently, the micro-processor 202 may determine the values based on the equations discussed in conjunction with the FIG. 4. Further, the micro-processor 202 aggregates group revenue, as depicted in Table 6. It will be apparent to a person skilled in the art that the group revenue has been included just for illustration purposes and different parameters, based on the requirement of the user, may also be included in Table 6 without limiting the scope of the disclosure. Although all the values of the parameter V3 have been mentioned as “Yes”, further limitations (e.g., “somewhat aligned with one of business strategy; and industry trends”) corresponding to the value of V3 may be obtained from Table 4.

In accordance with step 408, the first ratings and the second ratings are assigned to each of the first/second parameters. The micro-processor 202 may assign the ratings to each of the first/second parameters based on the rating table discussed in the step 408. In an embodiment, referring to Table 3, Table 4, and Table 6, the micro-processor 202 determines the first/second rating for the organizations BG-1-BG-14 as:

TABLE 7
Illustration of the first/second ratings for the block diagram 500

| | First dimension | | | | Second dimension | | | |
|---|---|---|---|---|---|---|---|---|
| | Rating | Rating | Rating | Rating | Rating | Rating | Rating | Rating |
| Organization | for E1 | for E2 | for E3 | for E4 | for V1 | for V2 | for V3 | for V4 |
| BG-1 | 7.5 | 5.0 | 5.0 | 0.0 | 7.5 | 5 | 10 | 10 |
| BG-2 | 10.0 | 10.0 | 7.5 | 5.0 | 5 | 0 | 7.5 | 7.5 |
| BG-3 | 7.5 | 2.5 | 5.0 | 5.0 | 7.5 | 10 | 5 | 5 |
| BG-4 | 2.5 | 10.0 | 0.0 | 0.0 | 2.5 | 0 | 5 | 5 |
| BG-5 | 10.0 | 10.0 | 7.5 | 2.5 | 10 | 5 | 5 | 5 |
| BG-6 | 10.0 | 10.0 | 7.5 | 5.0 | 5 | 5 | 2.5 | 2.5 |
| BG-7 | 10.0 | 7.5 | 10.0 | 2.5 | 5 | 5 | 7.5 | 7.5 |
| BG-8 | 0.0 | 2.5 | 0.0 | 0.0 | 10 | 5 | 10 | 10 |
| BG-9 | 5.0 | 2.5 | 5.0 | 0.0 | 2.5 | 0 | 2.5 | 2.5 |
| BG-10 | 10.0 | 10.0 | 2.5 | 7.5 | 2.5 | 10 | 10 | 10 |
| BG-11 | 2.5 | 2.5 | 0.0 | 0.0 | 7.5 | 0 | 5 | 5 |
| BG-12 | 7.5 | 10.0 | 2.5 | 0.0 | 7.5 | 5 | 10 | 10 |
| BG-13 | 10.0 | 10.0 | 0.0 | 2.5 | 10 | 5 | 10 | 10 |
| BG-14 | 7.5 | 10.0 | 0.0 | 2.5 | 7.5 | 5 | 10 | 10 |

It can be observed from Table 7 that each of the first/second parameters has been assigned a respective rating on a scale of 0-10. These ratings may be utilized to determine the first/second score as described below.

In accordance with step 410, the first score and the second score are determined. The micro-processor 202 determines the first/second score based on the first/second ratings. In an embodiment, the micro-processor 202 utilizes the equations (5)-(8) to determine the first/second score. Table 8 illustrates the determined first/second score corresponding to the organizations BG-1-BG-14:

TABLE 8
Illustration of determined first/second
score for the block diagram 500

| Organization | First score | Second score |
|---|---|---|
| BG-1 | 4.29 | 7.92 |
| BG-2 | 8.21 | 4.17 |
| BG-3 | 5.0 | 7.92 |
| BG-4 | 3.57 | 3.33 |
| BG-5 | 7.5 | 6.25 |
| BG-6 | 8.21 | 5.0 |
| BG-7 | 7.14 | 6.25 |
| BG-8 | 0.71 | 7.5 |
| BG-9 | 2.86 | 2.09 |
| BG-10 | 8.21 | 8.75 |
| BG-11 | 1.43 | 4.17 |
| BG-12 | 5.36 | 7.5 |
| BG-13 | 6.43 | 8.33 |
| BG-14 | 5.71 | 7.92 |

In accordance with step 412, the organizations BG-1-BG-14 are categorized. In an embodiment, the micro-processor 202 categorizes each of the organizations BG-1-BG-14 based on the first/second score. In an embodiment, utilizing the Table 5, the micro-processor 202 determines the category associated with each of the organization. Thus, based on the Table 5 and determined first/second score (refer Table 8), the micro-processor 202 determines the category for each of the organization BG-1-BG-14, as depicted in Table 9:

TABLE 9
Illustration of categories for different
organizations for the block diagram 500

| Organization | Category for the Organization |
|---|---|
| BG-1 | Visionary |
| BG-2 | Challenger |
| BG-3 | Visionary |
| BG-4 | Niche Player |
| BG-5 | Leader |
| BG-6 | Challenger |
| BG-7 | Leader |
| BG-8 | Visionary |
| BG-9 | Niche Player |
| BG-10 | Leader |
| BG-11 | Niche Player |
| BG-12 | Leader |
| BG-13 | Leader |
| BG-14 | Leader |

It can be observed from Table 9 that each of the organizations BG-1-BG-14 has been categories in one category (e.g., the leader, the visionary, the challenger, or the niche player). For example, as depicted, the organization BG-2 has been categorized as a challenger, whereas the organization BG-14 has been categorized as a leader. Further details about the meaning of different categories have already been discussed in conjunction with the FIG. 4.

In accordance with step 414, the categorized organizations BG-1-BG-14 are displayed on the display device associated with the user-computing device 102. As depicted in the block diagram 500, the categorized organizations BG-1-BG-14 are displayed on the Cartesian quadrant in the form of a bubble chart 502. Each of the categorized organization BG-1-BG-14 is displayed in the Cartesian quadrant. Further, the size of the bubbles in the bubble chart 502 corresponds to the revenue size illustrated in Table 6.

In an embodiment, displayed bubble chart 502 may be utilized by the user in assessing the innovation effectiveness of the organization. For example, the user may come to know that since the organization BG-10 has been categorized as a leader, it is well positioned today for executing its current innovation focus/goals, as well as it is well positioned for tomorrow in terms of innovation vision, roadmap, and investments.

In accordance with the step 416, the user may determine the innovation progress of the organization. For example, the user may observe the variation in the first/second score associated with the organization, or may observe the variation in the category of the organization, to determine the innovation progress of the organization.

The disclosed embodiments encompass numerous advantages. Determining innovation effectiveness of the organization is a complex and difficult task. Typically, organizations may measure the performance of individual innovation projects/portfolios. However, measuring the innovation effectiveness of the complete organization to determine how well the organization has performed in the past, how well the organization is performing today, or how well the organization will perform in future is a non-trivial problem. In various embodiments for the methods and systems for assessing the organizations, it is disclosed that the organizations may be characterized based on two dimensions (i.e., the first dimension and the second dimension), such that the first dimension may be deterministic of the current innovation strength of the organization and the second dimension may be deterministic of the future innovation strength of the organization. Further, different parameters (i.e., the first parameters and the second parameters) are included in the two dimensions that comprehensively and effectively capture the innovation outcomes of the organization.

In addition, utilizing the categorization of the organization, the user may assess the innovation progress of the organization. Based on the assessment, the user may further decide to change the strategies/roadmap planned for achieving the innovation goals of the organization. Further, as discussed, the users may compare the innovation progress of the organization with one or more other organizations. For example, by observing the position of the organization in the Cartesian quadrant (or in bubble chart), with respect to other organizations, the user may assess the innovation effectiveness of the organization in comparison to one or more competitor organizations.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as reception of data from other sources. The communication unit may include a modem, an Ethernet card, or other similar devices, which enable the computer system to connect to databases and networks, such as, LAN, MAN, WAN, and the Internet. The computer system facilitates input from a user through input devices accessible to the system through an I/O interface.

In order to process input data, the computer system executes a set of instructions that are stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or using only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’, Java, and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms including, but not limited to, ‘Unix’, DOS′, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for assessing organizations have been disclosed. However, it should be apparent to those skilled in the art that modifications, in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person having ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, or the like.

The claims can encompass embodiments for hardware, software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A system for assessing an organization, the system comprising:
a transceiver configured to:
receive values of each of one or more first parameters, associated with a first dimension, from one or more computing devices associated with said organization, wherein said first dimension corresponds to an existing innovation strength of said organization;
receive values of each of one or more second parameters, associated with a second dimension, from said one or more computing devices associated with said organization, wherein said second dimension corresponds to future innovation strength of said organization; and
one or more micro-processors configured to:
assign a first rating to each of said one or more first parameters based on said received values of each of said one or more first parameters;
determine a first score corresponding to said first dimension based on at least said first rating;
assign a second rating to each of said one or more second parameters based on said received values of each of said one or more second parameters;
determine a second score corresponding to said second dimension based on at least said second rating;
categorize said organization in one or more categories based on said first score and said second score,
wherein said transceiver is further configured to send said categorization of said organization to said one or more computing devices, wherein said categorization of said organization is displayed through a user-interface on a display device of said one or more computing devices.

2. The system of claim 1, wherein said first rating for each of said one or more first parameters is determined based on a first value associated with respective first parameter.

3. The system of claim 1, wherein said second rating for each of said one or more second parameters is determined based on a second value associated with respective second parameter.

4. The system of claim 1, wherein said one or more first parameters correspond to at least one of a return on investment from innovation initiatives, a contribution of innovation in said organization's revenue, a contribution of innovation in said organization's profit growth, a count of innovations commercialized, a measure of strength of said organization to execute and/or commercialize innovation, and a measure of strength of said organization's innovation capability determined based on organization's rank among one or more competitor organizations.

5. The system of claim 1, said one or more second parameters correspond to at least one of said organization's investment in innovation, a count of innovations in pipeline, a status of said organization's innovation strategy being aligned with said organization's overall strategy determinable from innovation roadmap of said organization, or an expected return on investment from innovation initiatives.

6. The system of claim 1, wherein said organization is categorized in at least one of a leader category, a visionary category, a challenger category, or a niche player category.

7. The system of claim 6, wherein said categorization of said organization is displayed through said user interface in at least a Cartesian quadrant on said display device of said one or more computing devices.

8. The system of claim 7, wherein said one or more micro-processors are further configured to determine an innovation progress associated with said organization based on a variation in said categorization over a period of time.

9. The system of claim 1 further comprising an image capturing device configured to scan one or more documents, wherein said one or more documents include information pertaining to said one or more first parameters and said one or more second parameters.

10. The system of claim 9 further comprising a natural language processor configured to analyze said one or more scanned documents to determine said values of said one or more first parameters and said one or more second parameters.

11. A method for assessing an organization, the method comprising:
receiving, by a transceiver, values of each of one or more first parameters, associated with a first dimension, from one or more computing devices associated with said organization, wherein said first dimension corresponds to an existing innovation strength of said organization;
receiving, by said transceiver, values of each of one or more second parameters, associated with a second dimension, from said one or more computing devices associated with said organization, wherein said second dimension corresponds to future innovation strength of said organization;
assigning, by one or more micro-processors, a first rating to each of said one or more first parameters based on said received values of each of said one or more first parameters;
determining, by said one or more micro-processors, a first score corresponding to said first dimension based on at least said first rating;
assigning, by said one or more micro-processors, a second rating to each of said one or more second parameters based on said received values of each of said one or more second parameters;
determining, by said one or more micro-processors, a second score corresponding to said second dimension based on at least said second rating;
categorizing, by said one or more micro-processors, said organization in one or more categories based on said first score and said second score; and
sending, by said transceiver, said categorization of said organization to said one or more computing devices, wherein said categorization of said organization is displayed through a user-interface on a display device of said one or more computing devices.

12. The method of claim 11, wherein said first rating for each of said one or more first parameters is determined based on a first value associated with respective first parameter.

13. The method of claim 11, wherein said second rating for each of said one or more second parameters is determined based on a second value associated with respective second parameter.

14. The method of claim 11, wherein said one or more first parameters correspond to at least one of a return on investment from innovation initiatives, a contribution of innovation in said organization's revenue, a contribution of innovation in said organization's profit growth, a count of innovations commercialized, a measure of strength of said organization to execute and/or commercialize innovation, and a measure of strength of said organization's innovation capability determined based on organization's rank among one or more competitor organizations.

15. The method of claim 11, wherein said one or more second parameters correspond to at least one of said organization's investment in innovation, a count of innovations in pipeline, a status of said organization's innovation strategy being aligned with said organization's overall strategy determinable from innovation roadmap of said organization, or an expected return on investment from innovation initiatives.

16. The method of claim 11, wherein said organization is categorized in at least one of a leader category, a visionary category, a challenger category, or a niche player category.

17. The method of claim 16, wherein said categorization of said organization is displayed through said user interface in at least a Cartesian quadrant on said display device of said one or more computing devices.

18. The method of claim 17 further comprising determining, by said one or more micro-processors, an innovation progress associated with said organization based on a variation in said categorization over a period of time.

19. The method of claim 11 further comprising scanning, by an image capturing device, one or more documents, wherein said one or more documents include information pertaining to said one or more first parameters and said one or more second parameters, wherein said values of said one or more first parameters and said one or more second parameters are determined based on said scanning.

20. A computer program product for use with a computer, the computer program product comprising a non-transitory computer readable medium, wherein the non-transitory computer readable medium stores a computer program code for assessing an organization, wherein the computer program code is executable by one or more micro-processors to:
receive, by a transceiver, values of each of one or more first parameters, associated with a first dimension, from one or more computing devices associated with said organization, wherein said first dimension corresponds to an existing innovation strength of said organization;
receive, by said transceiver, values of each of one or more second parameters, associated with a second dimension, from said one or more computing devices associated with said organization, wherein said second dimension corresponds to future innovation strength of said organization;
assign, by said one or more micro-processors, a first rating to each of said one or more first parameters based on said received values of each of said one or more first parameters;
determine, by said one or more micro-processors, a first score corresponding to said first dimension based on at least said first rating;
assign, by said one or more micro-processors, a second rating to each of said one or more second parameters based on said received values of each of said one or more second parameters;
determine, by said one or more micro-processors, a second score corresponding to said second dimension based on at least said second rating;
categorize, by said one or more micro-processors, said organization in one or more categories based on said first score and said second score; and
send, by said transceiver, said categorization of said organization to said one or more computing devices, wherein said categorization of said organization is displayed through a user-interface on a display device of said one or more computing devices.
